(19) United States
(12) Patent Application Publication
(10) Pub. No.: US 2007/0156437 A1
(43) Pub. Date: Jul. 5, 2007

(54) AUTOMATED METHOD, SYSTEM, AND PROGRAM FOR AIDING IN PRODUCT ADVERTISEMENT

(75) Inventors: ERIC EDWARDS, West Henrietta, NY (US); Christopher Mann, Pittsford, NY (US); Jacqueline Parks, Honeoye Falls, NY (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(73) Assignee: Voiceport, LLC

(21) Appl. No.: 11/564,284

(22) Filed: Nov. 28, 2006

Related U.S. Application Data
(60) Provisional application No. 60/740,177, filed on Nov. 28, 2005.
(60) Provisional application No. 60/740,182, filed on Nov. 28, 2005.

(51) Int. Cl. G06Q 99/00

(52) U.S. Cl. 705/1

(57) ABSTRACT

The disclosed subject matter involves marketing a client's product to third parties. The client defines the information to communicate to the third parties. Said information is entered into an automated system which third parties are able to contact at their discretion. When the third party contacts the system, the system relays the advertisement to the third party.

This application claims the benefit of priority to U.S. Provisional Patent Application No. 60/740,177 entitled “PERSONA-DRIVEN METHOD FOR COMPILING ADVERTISING DATA USING VOICE INTERFACE SYSTEM,” by Eric Edwards filed on Nov. 28, 2005, and is incorporated herein by reference as if fully set forth herein. This application also claims the benefit of priority to U.S. Provisional Patent Application No. 60/740,182 entitled “METHOD FOR COMPILING ADVERTISING DATA USING VOICE INTERFACE SYSTEM,” by Eric Edwards filed on Nov. 28, 2005, and is incorporated herein by reference as if fully set forth herein.

This application incorporates by reference the co-pending patent application entitled “AUTOMATED METHOD, SYSTEM, AND PROGRAM FOR AIDING IN STRATEGIC MARKETING”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR AIDING IN PRODUCT COMPLIANCE AND ADHERENCE”, by Eric Edwards filed on Nov. 28, 2006, and is incorporated herein by reference as if fully set forth herein.

This application incorporates by reference the co-pending patent application entitled “AUTOMATED METHOD, SYSTEM, AND PROGRAM FOR GENERATION OF AN AUDIO SURVEY”, by Eric Edwards filed on Nov. 28, 2006, and is incorporated herein by reference as if fully set forth herein.

### TECHNICAL FIELD OF THE INVENTION

The disclosed subject matter relates to product advertisement. More specifically, the disclosed subject matter deals with the interaction between traditional forms of advertising and targeted audio advertisements to promote a product.

### BACKGROUND OF THE INVENTION

A problem with advertising lies in the ability to tailor an advertisement which can be received by the most potential customers and conveys all applicable information in an economical manner. If the advertisement goes out to everyone as opposed to potential customers, then the advertisement might go to those who will not purchase the product. The advertisement should be conducive to the potential customers paying attention to the advertisement. If the length of the advertisement goes too long, then the price of the advertisement increases. If the advertisement runs long or comes at an inconvenient time, then the potential customer might not pay attention to it. A need for getting a third party's attention in advertisements with a way to follow up with more information is needed.

A common method for targeted advertisement involves the use of direct mailings. The client takes a list of third parties and sends them an advertisement for a product. These advertisements range from simple cards alerting the customer to the product's existence to complete information packages on the product. The more complex the written material, the more expensive the advertisement.

Another form of targeted advertisement comes from an in person visit by a client's representative. This allows one-on-one personal interaction between the third party and the client. Usually, restrictions on the time of both parties are involved, making these visits brief. A client's representative might have an entire catalogue of products to tell the third party about, but only have time to give his presentation on one or two high profile products.

As these two forms of targeted advertisement demonstrate, clients have a difficult time giving all the relevant information on the product to third parties in a cost effective manner. Both forms have serious restrictions, either by quality of information relayed or amount of time available. There exists a need to follow up advertisement for use at the third party's convenience that can persuasively communicate the need to purchase the product.

Communication between the client and the third party helps to address this inefficiency of advertisement. Obstacles to communication include identifying the third parties and establishing a mechanism to communicate between the client and the third party. This presents a difficulty without a preexisting relationship between the client and the third party. Without some form of contact, advertisement is not possible.

Telephone calls offer a considerable advantage to other modes of communication such as direct mail or in person solicitation. Use of the telephone does offer some drawbacks. Telephone calls take a large staff to make the number of calls necessary to contact all the third parties. Companies could have employees make these calls, but those employees could perform other needed duties. The client could contract the responsibility to call centers, but that becomes expensive. This commitment of resources makes telephone calls prohibitive for all but large companies to make follow up calls. Even large companies might find it economical to use telephone calls only on high value items.

The disclosed subject matter involves marketing a client's product to third parties. The client defines the information to communicate to the third parties. Said information is entered into an automated system which third parties are able to contact at their discretion. When the third party contacts the system, the system relays the advertisement to the third party.

### SUMMARY OF THE INVENTION

The method and system illustrated and described herein have several features, no single one of which is solely responsible for its desirable attributes. Without limiting the scope as expressed by the description that follows, its more prominent features will now be discussed briefly. After considering this discussion, and particularly after reading the section entitled “DETAILED DESCRIPTION OF THE ILLUSTRATIVE EMBODIMENTS” one will understand how the features of the disclosed subject matter provide for the analysis of source code.

The disclosed subject matter involves marketing a client's product to third parties. The client defines the information to communicate to the third parties. Said information is entered into an automated system which third parties are able to contact at their discretion. When the third party contacts the system, the system relays the advertisement to the third party.

The disclosed subject matter provides a method and system for aiding in product advertisement. Possible embodiments deal with follow up to direct mail and follow up to in person solicitation. While the present disclosed subject matter can be applied to numerous applications, this application will illustrate the patent as is applies to the pharmaceutical industry as an example. The disclosed subject matter will provide a service of advertisement calls, as directed by the client who manufactures the product for the third party who uses the product.

A component of the disclosed subject matter involves defining the product information to communicate to third parties. The disclosed subject matter collects the information in several ways. One method involves the client interacting with an automated system. The method and system would determine how to categorize the product. The method and system would ask the client a series of questions to determine the content of the advertisement. In this example, the method and system would be defined as a pharmaceutical. The basis of the following questions comes from commonly asked questions involved advertisements in the pharmaceutical field.

Alternatively, a personal service agent from the service provider can collect advertisement information to craft a unique advertisement. Customization allows the client greater flexibility in the service. Other alternatives include the client creating their own advertisements and having the service provider simply provide the delivery vehicle.

Upon establishing the content of the advertisements the system processes the information into an audio advertisement with a particular persona. An example would include a stereotypical mechanic with perhaps some garage sounds in the background if the product deals with automotive issues. Another example would use a nurse at a hospital asking health related questions, as in the case of a pharmaceutical product. There would be no limit to the number of personas available. Other alternatives allow the voice used in the calls to come from a particular voice actor as opposed to a standard voice offered by the service provider.

Now that the advertisement is created, the applicable third parties need to contact the service provider to receive the advertisement. The third party can receive the contact information in any possible format. Available choices include a personal contact from a sales representative or through direct mail to give the third parties the contact information for the service provider.

Once the third party contacts the service provider, there are three possibilities in the current embodiment. First, the service provider number called might only have one product associated with it. In that case, the advertisement will give all the applicable information. Secondly, the service provider could advertise more than one product available at that contact number, but the specific advertisement is selected by name or number. The applicable information is dispensed when selected.

A third option is the advertisements to be interactive. The third party will call the number and answer a series of questions. Answers to these questions determine the third party's needs. These questions will narrow in scope until the third party's needs can be defined in terms of the client's product.

The questions can also help determine a third party's needs in term of products not yet available. This gives the client access to a survey of knowledge that suggests what products third parties would in purchase in the future.

Once the third party's needs are defined in terms of a client's product, the advertisement begins. The applicable information is given to the third party. The third party can order samples of the product for use as applicable.

A factor for consideration when generating the advertisements is the length of the call. The disclosed subject matter will approximate how long each call will take. This could be a relevant factor for cost purposes or for optimum use of the service. One embodiment of the disclosed subject matter offers the service by charging per minute of phone time used in the service. The client might want to consider the trade off of using a more calls with shorter advertisements or more calls with longer advertisements.

### BRIEF DESCRIPTION OF DRAWINGS

The accompanying drawings, which are incorporated in and constitute a part of this specification, illustrate several embodiments of the invention and together with the description, serve to explain the principles of the invention.

FIG. 1 presents a general overview of the disclosed subject matter. The information is collected by the service provider from the client. The service provider then receives third party contact information. The service provider gives the third party information on the product;

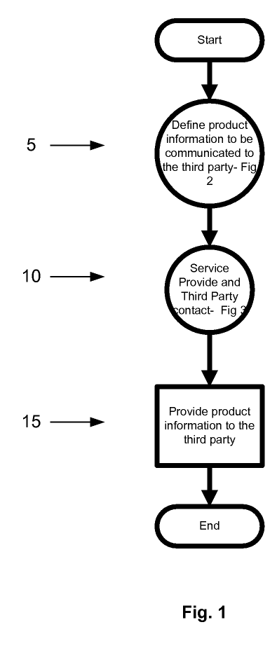

FIG. 2 shows the mechanics of using an automated system for advertisement generation. The information is collected by the service provider from the client and converted into an automated advertisement of an appropriate type;

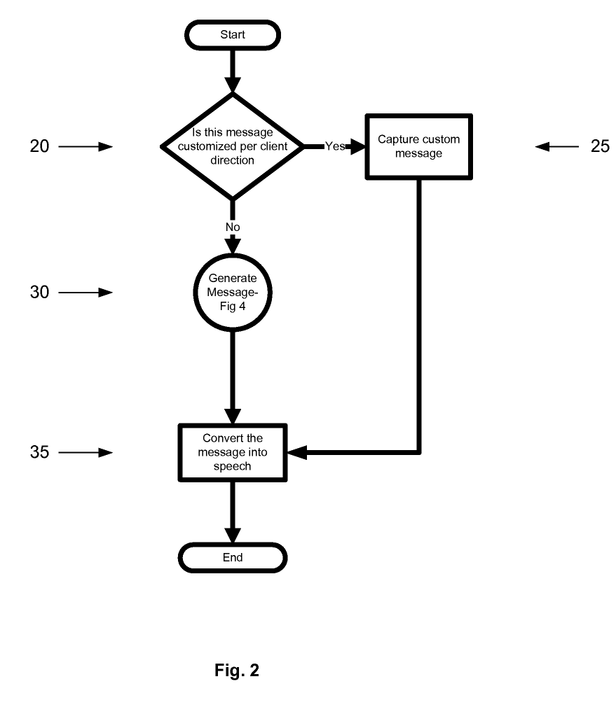

FIG. 3 depicts how the service provider receives the third party contact information;

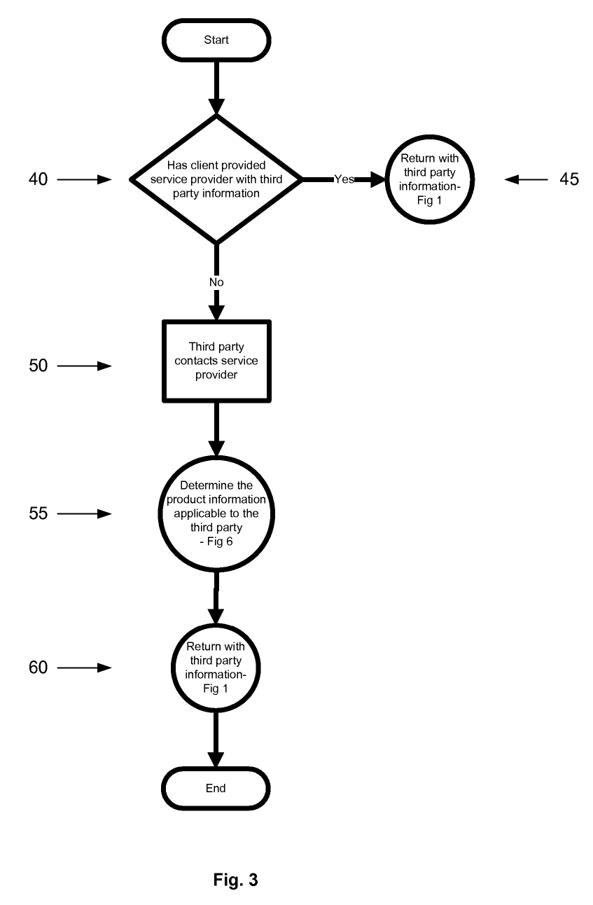

FIG. 4 is an algorithm useful for generating the advertisements;

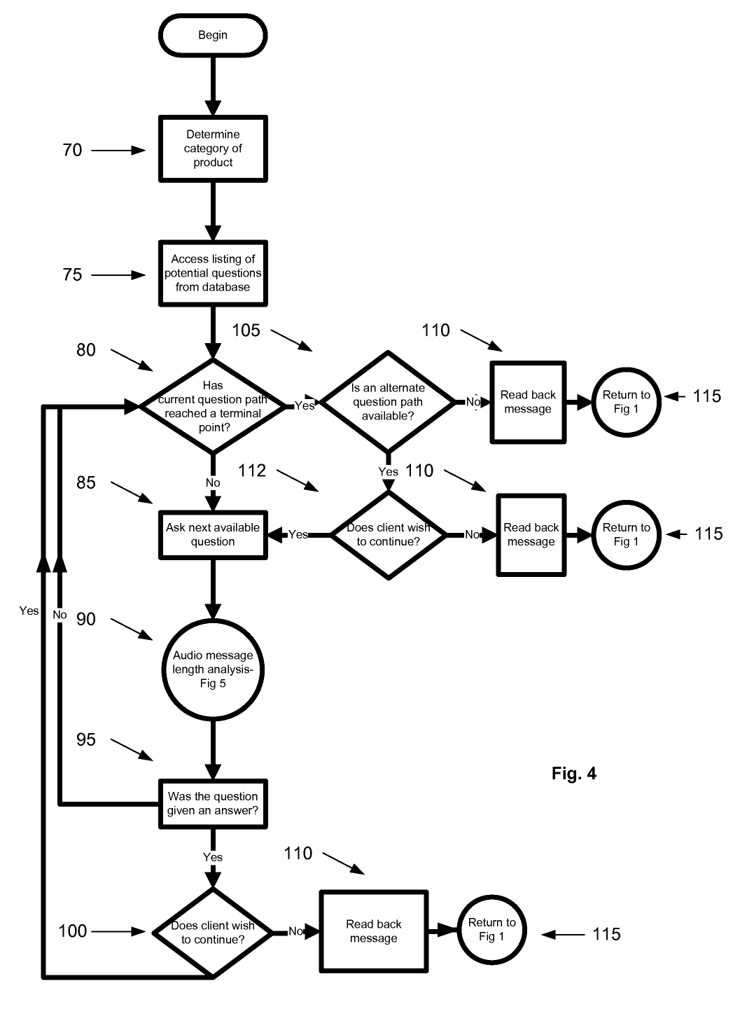

FIG. 5 provides an audio length algorithm for use in one embodiment where advertisement length is a factor of concern; and

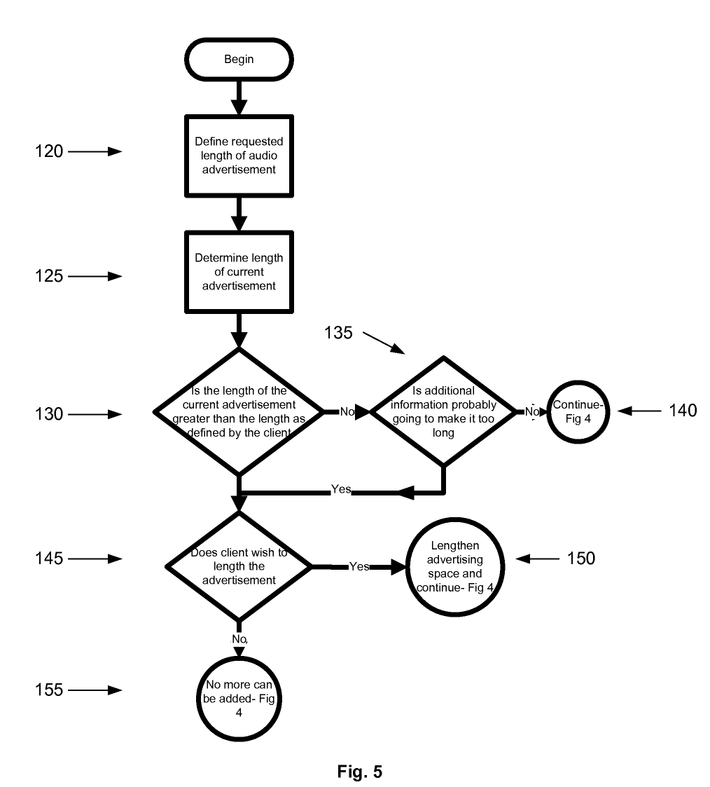

FIG. 6 shows the process of using third party input to determine the appropriate advertisement to present to the third party.

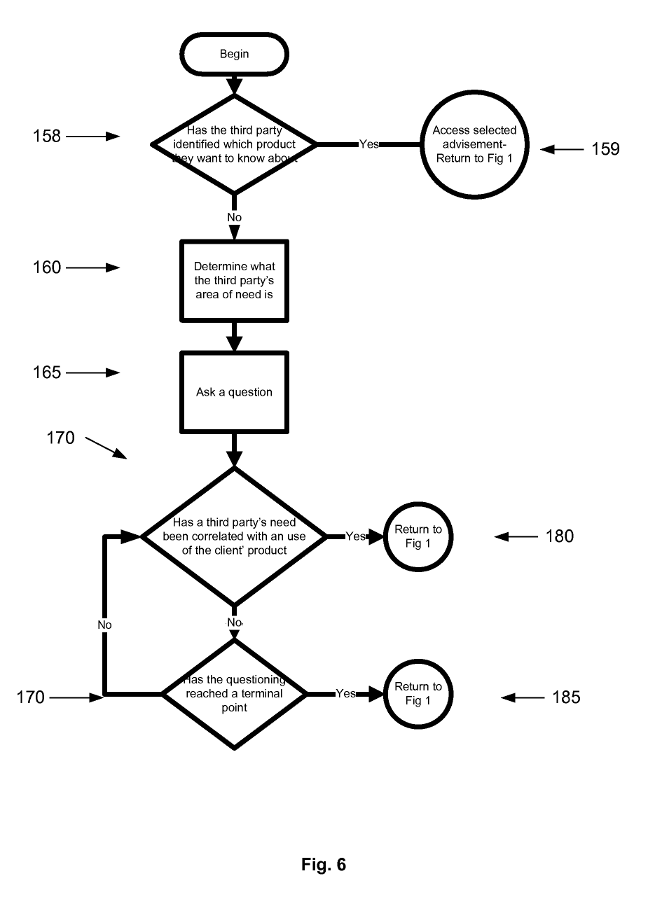

### DETAILED DESCRIPTION OF PREFERRED EMBODIMENTS

The disclosed subject matter involves marketing a client's product to third parties. The client defines the information to communicate to the third parties. Said information is entered into an automated system which third parties are able to contact at their discretion. When the third party contacts the system, the system relays the advertisement to the third party.

Although described with particular reference to a systems environment, the claimed subject matter can be implemented in a plurality of information technology (IT) systems. Those with skill in the electronic telecommunications arts will recognize that the disclosed embodiments may be realized in ways in addition to those specific examples described below. In addition, the methods of the disclosed subject matter can be implemented using a variety of combinations of software and hardware. The hardware portion can be implemented using specialized logic; the software portion can be stored in a memory and executed by a suitable instruction execution system such as a microprocessor, PC or mainframe.

All references, including publications, patent applications, and patents, cited herein are hereby incorporated by reference to the same extent as if each reference were individually and specifically indicated to be incorporated by reference and were set forth in its entirety herein.

In the context of this document, a “memory” can be any means that contains stores, communicates, propagates, or transports the program and/or data for use by or in conjunction with an instruction execution system, apparatus or device. Memory, recording medium and data store can be, but are not limited to, an electronic, magnetic, optical, electromagnetic, infrared or semiconductor system, apparatus or device. Memory, recording medium and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The disclosed subject matter may be described in the general context of computer-executable instructions, such as program modules, being executed by a computer. Generally, program modules include routines, programs, objects, components, data structures, etc. that performs particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

Preferred embodiments of this disclosed subject matter are described herein, including the best mode known to the inventors for carrying out the disclosed subject matter. Variations of those preferred embodiments may become apparent to those of ordinary skill in the art upon reading the foregoing description. The inventors expect skilled artisans to employ such variations as appropriate, and the inventors intend for the disclosed subject matter to be practiced otherwise than as specifically described herein. Accordingly, this disclosed subject matter includes all modifications and equivalents of the subject matter recited in the claims appended hereto as permitted by applicable law. Moreover, any combination of the above-described elements in all possible variations thereof is encompassed by the disclosed subject matter unless otherwise indicated herein or otherwise clearly contradicted by context.

Although the present disclosed subject matter has been described in detail herein with reference to the illustrative embodiments, it should be understood that the description is by way of example only and is not to be construed in a limiting sense. It is to be further understood, therefore, that numerous changes in the details of the embodiments of this disclosed subject matter and additional embodiments of this disclosed subject matter will be apparent to, and may be made by, persons of ordinary skill in the art having reference to this description. It is contemplated that all such changes and additional embodiments are within the spirit and true scope of this disclosed subject matter as claimed below.

The disclosed subject matter generates a series of audio advertisements for clients to communicate with third parties about a client's product. The disclosed subject matter incorporates certain rules and patterns that have been observed in the structure of information communicated to third parties by clients with additional intelligence from external sources of sales-item data. This methodology provides the algorithmic basis of the advertisement generation process along with the advertisements themselves. The current disclosed subject matter utilizes state of the art voice user interface techniques to provide a comfortable and intuitive interaction with the client or third party. Although the current disclosed subject matter may find a use for any product or service that would benefit from such contact, the exemplary discussion herein will focus on compliance and adherence calls in the pharmaceutical industry.

The current disclosed subject matter includes a way to capture client information for creating an audio advertisement. The purpose of the disclosed subject matter is to gather information about the client's product and thereby build advertisements. The information received for call generation come from the client using any source, including telephone and web based systems. For example purposes, audio input generation will be used to create audio advertisements, while alternatives such as web based format remain available. For example purposes, communication with third parties can use any medium, including telephone and web based systems.

The impetus for the third parties to call the service provider can come from any source. Direct mail provides an example of targeting the intended third parties. Direct mail has long been a traditional method of mass advertisement. The economic aspects have been in tension with the level of information disclosed. If a direct mail advisement is too informative, it might be too expensive and not return sufficient results for the effort. Conversely, interested third parties might not have their interest piqued enough to buy the product with a sparse direct mailing. Using this disclosed subject matter, a direct mailing only has to give basic information and invites the third party to follow up with a phone call to the service provider. The service provider then provides the third party the pre generated advertisement. The same contact information communication can be made available through catalogs.

Another way to inform the third party about the advertisement contact information comes from the customer service representatives of the client. When a customer service representative solicits sales through in person visits to prospective third parties, there is usually a very limited amount of time to communicate all the relevant information about a product. The representative might have a multitude of products to sell, but only have enough time to talk about one or two. The service provider can leave a small pamphlet with the third party and instruct them about other products available and how to make contact.

In the example used in this description, the embodiment would involve the product manufacturer being a client of a service provider. Alternatively, the service can be provided by the company who want the calls made by an in-house department. Moreover, the client and the service provider can be one in the same.

The system defines the information to communicate to third parties 5. The disclosed subject matter uses an algorithm to generate such information from the client or the client can directly create the information.

Once the client's advertisement is generated in this example, the third party contacts the service provider 10. The advertisements can then be provided to third parties 15.

An aspect used in some embodiments of the disclosed subject matter to generate the questions and responses to aid in advertising development comes from the use of a database. The database contains information on what the typical client advertisements tell a third party. This database can contain information for a plurality of possible products. The data base also contains a bank of automated input promotes and outputs tat the client can dynamically control in the message advertisement generation.

An alternative embodiment allows the client to customize their advertisements by directly providing the service provider with exactly what the client wants the advertisements to communicate without use of the database. The alternative would allow the client the ability to select exactly what they want the advertisements to say. Another alternative available to the client would use personal contact with the service provider. This would allow a collaborative process where both parties come up with a particular set of inputs and outputs for the advertisements. If the client chooses a customized advertisement 20, the advertisement generated by this customized process would be the one used in the system 25. When the customized advertisement processes in the system, it will be converted into an audio message 35.

Otherwise, the service has a list of standard questions and prompts available to aid in message generation. These questions come from a plurality of wedge bases that have the information needed for the advertisements. As the disclosed subject matter begins, the client receives a query for basic details about the product they are selling. In this example, the category would be something similar to ‘medication’. The product classification returns a series of relevant and appropriate prompts, which ask the client to select from this list of the product's criteria based on the classification. The prompts over the telephone system are designed to be conversational and direct, and therefore will elicit responses that are natural to the caller and, likely to be recognized by the system. Alternatively, some responses accept input on the telephone keypad.

If the information used in advertisement comes from a standardized system as opposed to a custom one, the system then generates the advertisement per the embodiment 30. Once all of the information is collected, the system converts the information into the advertisement in audio format 35. The audio format takes on one of a number of personas. The persona used for the advertisement relates to the type of information being communicated. One available embodiment directs the persona used based on the knowledge base. These personas suggest attributes of the speaker that foster creditability in what the advertisement says. Examples include a nurse dispensing medical information, a mechanic talking about a car, a lawyer talking about legal issues, or a pollster asking about how a person plans on voting. Optional sounds include background noises, such as the sound of a hospital in the background for a nurse, or sounds of a garage for a mechanic.

An alternative to the use of a particular persona would be the use of a specified voice actor. This could allow more customization to the client.

The disclosed subject matter then makes contact with third parties. In some embodiments, the client might already have the applicable third party contact information and have provided it to the service provider 40. If so, no more data collection is needed 45. In the example used for illustrative purpose, the service provider does not start with the third party's contact information. In this context, the third party would have to initiate contact with the service provider in order for the service provider to recite the advertisement 50. When the third party makes contact with the service provider, the service provider determines the applicable advertisement to give the third party 55. This advertisement goes to the applicable areas for commutation with the client 60.

When generating the advertisement, the system approaches the information collection for the advertisement in a predetermined manner. The following example will describe a possible algorithm used to collect information from the client. These bullets denote the information that is initially collected from the client to determine the proper categorization 70:
Type of product (Medication)
Type of medication (allergy, heart)
Sub-classification of medication (“decongestant, fever reducer”)

Next, the initially collected information is used to select a capture profile specific to the product. The capture profile consists of a series of capture items that are presented to the caller in sequence to collect additional information about the product. Examples of capture items are 75:
Medication name
Reason to take the medication
Recommended dosage
Recommended schedule
Notes
Warnings

The general algorithm repeats until a termination condition is met. Answers to questions drive subsequent questions to obtain applicable details from the client. The system will also look to see if a question on the list that has not been asked 80. If so, then the system will present the question to the client 85. After the question is asked, the system then analyzes the entire advertisement for audio advertisement length 90. If no answer to the question was given, the system goes to the next question 95. If the client does not wish to continue with the questions, the process completes and the advertisement generates 100. Once a path of questions has been exhausted, the system looks to see if an alternate path of questioning exists 105. If there is no available alternate path, the system reads back the advertisement at that time and generates the advertisement 110. When an alternate path exists, the system asks if the client wishes to continue 112. If so, the system continues with the new question list 85. If not, the system generates the advertisement 110. When the advertisement generation ends, the result is retuned back to the relevant portion of the system 115.

The system confirms with the client every piece of information. Failure to confirm or collect a piece of information (for example, repeatedly failing to recognize their last name) results in the caller being transferred to an agent or another alternate based on the embodiment.

An optional aspect of the disclosed subject matter relates to the cost of the service. Some embodiments of the service give the client the option to limit the cost of the service provided by making the cost of the call fall within a set price boundary 120 in embodiments that charge for the service per the amount of time for each detriment. In doing so, the system will define the amount of time that is applicable to the cost the client wants to spend. This can be used to determine if the advertisement can be lengthened or needs to be reduced.

The system calculates audio advertisement length by use of an algorithm, converting the advertisement into audio format, or other method to those known in the art to determine the resulting advertisement length 125. Based on the returned length of the advertisement, the system will do one of the following:
Check the length of the advertisement and see if it is within the amount paid for 130.
If the most recently added item has raised the price for the advertisement notify the client that the item does not fit 145. Read the advertisement text back and query if they would like to include the most recent item and possibly more in the advertisement and raise the limit on the price per call. If they select more 150, then the process continues. If they choose not to purchase more time per call, then the advisement is concluded 155.
If there is likely additional time available at the current price quoted initially 135 move on to the next capture item 140.
If the advertisement does not likely have additional time at the current price 135, read the advertisement text and current price back to the customer and query if they would like to include more in the advertisement and raise the limit on the price of the call 145.

The algorithm continues until the content of the advertisement meets the client's requirements or all capture items have been presented. The system reads the advertisement back to the client for verification.

The system confirms with the client every piece of information whether it already exists or is collected new from the caller (in the case of incorrect or no information). Failure to confirm or collect a piece of information (for example, repeatedly fails to recognize their last name) results in the caller being transferred to an agent or another alternate based on the program.

When third parties call the service provider, there are several possibilities as to how the third party will access the advertisement they are looking for. The phone number called may relate to one specific product only. In that instance, the advertisement begins automatically. In an alternate version, there multiple products might have the same contact information. The third party would have to select which product they want to receive information about.

Different embodiments approach the information to disclose in different ways. If the system receives a prompt to direct the third party to a specific advertisements 158, then the service provider access the product advertisement 159. Another alternative for advertisement occurs when the third party does not call about a specific product, but calling to see if a client has a product that suits their needs. The service could take the information that was collected from the client about the product and use an algorithm to see if the client has a product that meets the needs of the third party, accessing a database containing information on a client's product 160. The service provider asks the third party a series of questions 165. If the answer suggests a client product 170, then that product is suggested 180. If a product does not meet the third party's needs, then the system looks to see if there are other possible products available 175. If there are no more available products, then the system returns no value 185. If the system can find other questions, it will repeat the process until the options are exhausted or there is a defined product 175.

Another option for the system allows for the capture of billing information. The system checks the customer database for a matching account using the client's name and number. If there is an associated account then the address in the account is confirmed with the caller. Failure to confirm the existing account address will cause the caller to go to an agent. If there is no account then the system collects the caller's address from the caller and creates a new account. In both cases, the advertisement is saved.

If there is no account and collecting the address for the new account fails then a new account is made with the unknown fields marked as incomplete and the advertisement is saved. The caller is then transferred to an agent. During the transfer, the agent is informed (via whisper) that the advertisement has been saved but the name and address fields are incomplete.

The service provider also collects information from the third parties for use in real time analysis for the client. The client can ask the service provider for information to evaluate sales and break the information down by region, specialty, or any other measurable criteria. The information collected can suggest what products clients are interested in purchasing.

An additional option to add to the advertisement is the ability to automatically mail a sample of the product to the third party. Using this option, the service provider asks the third party if third party would like a sample of the product. If the third party agrees, then the service provider collects the third party's shipping information. The service provider arranges for the sample shipping. This can be accomplished in any way agreed upon between the service provider and the client. The client can receive a listing from the service provider and ship to the third party. Alternately, the service provider can have a stock of samples available and ship them to the third party without any interaction from the client.

The disclosed subject matter described herein is a fundamentally novel method and system. By facilitating the collection of information to communicate to third parties on behalf of clients, a service provider can aid a client in informing third parties about the client's product. Following a standardized algorithm, the advertisements are generated in a manner that facilitates easy communication in a creditable manner over a communications medium to the third parties.

Various changes and modification to the embodiments herein chose for the purposes of illustration will readily occur to those skilled in the art. To the extent that such modifications and variations do not depart form the spirit of the invention, they are intended to be included within the scope thereof which is assessed only by fair interpretation of the following claims.

What is claimed is:

1. The method for marketing a client's medical product comprising the steps of:
defining information communicated by the manufacturer concerning the uses of the client's product;
inputting said information into an automated system; and
informing the third party concerning the client's product through said automated system.

2. The method of claim 1 for providing said third party with said product information, further comprising the steps of:
accessing a knowledge base associated with the product information;
asking the client questions related to the product; and
creating an advertisement based on responses to said questions asked.

3. The method of claim 2 for providing said third party with said product information, further comprising the steps of:
converting the advertisement into an audio format with a predetermined vocal persona; and
transmitting said advertisement.

4. The method of claim 1 where said information is spoken to the third party by a predetermined vocal persona.

5. The method of claim 1 where informing the third party further comprises the steps of:
asking the third party screening questions to determine the third party's medical needs;
selecting from a plurality of questions those most relevant to the third party's medical needs to define a subset of questions based on response to said screening questions; and
refining from said subset of questions further subsets of questions to define the third party's medical need in terms of a client's product.

6. The method of claim 1 where a client dynamically controls the audio recordings by manipulating a prerecorded bank of automated input prompts and outputs.

7. A method for marketing a client's product comprising the steps of:
defining information communicated by the manufacturer concerning the uses of the client's product;
inputting said information into an automated system; and
informing the third party concerning the client's product through said automated system.

8. The method of claim 7 for creating an audio advertisement, further comprising the steps of:
accessing a knowledge base associated with the product information;
asking the client questions; and
creating an advertisement based on responses to said questions asked.

9. The method of claim 8 for creating an audio advertisement, further comprising the steps of:
converting the advertisement into an audio format with a predetermined vocal persona; and
transmitting said advertisement.

10. The method of claim 7 where said information is spoken to the third party by a predetermined vocal persona.

11. The method of claim 7 where informing the third party further comprises the steps of:
asking the third party screening questions to determine the third party's needs;
selecting from a plurality of questions those most relevant to the third party's needs to define a subset of questions based on response to said screening questions; and
refining from said subset of questions further subsets of questions until the identification of the third party's needs in terms of said client's product.

12. The method of claim 7 where a client dynamically controls the audio recordings by manipulating a prerecorded bank of automated input prompts and outputs.

13. A system for marketing a client's product comprising:
a general purpose computer capable of executing a portion of instruction set of a software product;
a software product where the software product controls a general purpose computer performing the following instruction sets:
a set of instructions to define information communicated by the manufacturer concerning the client's product;
a set of instructions to input said information into an automated system; and
a set of instructions to informing the third party concerning the client's product through said automated system.

14. The system of claim 13 where said system contains instructions for providing a third party with product information comprising the steps of:
accessing a knowledge base associated with the product information;
asking the client questions; and
creating an advertisement based on responses to said questions asked.

15. The system of claim 14 for providing said third party with said client's product information, further comprising the steps of:
converting the advertisement into an audio format with a predetermined vocal persona; and
transmitting said advertisement.

16. The system of claim 13 where said system contains instructions for communicating said information spoken to the third party by a predetermined vocal persona.

17. The system of claim 13 where said system contains instructions for informing the third party further comprising:
asking the third party screening questions to determine the third party's needs;
selecting from a plurality of questions those most relevant to the third party's needs to define a subset of questions based on response to said screening questions; and
refining from said subset of questions further subsets of questions until the identification of the third party's needs in terms of said client's product.

18. The system of claim 13 where said system contains a memory unit where a client dynamically controls an audio recording derived from a prerecorded bank of automated input prompts and outputs.

19. A computer usable medium having a computer readable program code means embodied therein for creating an advertisement by way of an automated communications system, the computer usable medium comprising:
a computer readable program code means for defining information communicated by the manufacturer concerning the client's product;
a computer readable program code means for inputting said information into an automated system; and
a computer readable program code means for informing the third party concerning the client's product through said automated system.

20. The computer usable medium of claim 19 providing said third party with said client's product information occurs by:
accessing a knowledge base associated with the product information;
asking the third party questions; and
creating an advertisement based on responses to said questions asked.

21. The computer usable medium of claim 20 of providing said third party with said client's product information, further comprising the steps of:
converting the advertisement into an audio format with a predetermined vocal persona; and
transmitting said advertisement.

22. The computer usable medium of claim 19 where said information is spoken to the third party by a predetermined vocal persona.

23. The computer usable medium of claim 19 where informing the third party concerning the correct client's product comprises:
asking the third party screening questions to determine the third party's needs;
selecting from a plurality of questions those most relevant to the third party's needs to define a subset of questions based on response to said screening questions; and
refining from said subset of questions further subsets of questions until the identification of the third party's needs in terms of said client's product.

24. The computer usable medium of claim 19 where a client dynamically controls the audio recordings by manipulating a prerecorded bank of automated input prompts and outputs.

25. The method for marketing a product comprising the steps of:
reviewing information relating to an end user's use of a product, wherein the end user is targeted to be contacted based on that use;
gathering information based on the reviewed information regarding an end user's use of a product to be communicated to the end user; and
communicating to the end user gathered information relating to proper use of the product via an automated message system, wherein the gathered information is communicated to the end user.

26. The method of claim 25 where the gathering information further comprises collecting the data from a party manufacturing the product, a party selling the product, a party promoting a product, or a party purchasing the product for resale.

27. The method of claim 25, where the communicating step further comprising an audio message using a predetermined vocal persona.

28. The method of claim 25, wherein the step of gathering information, further comprises the steps of:
accessing a knowledge base based on the reviewed information;
associating reviewed information with appropriate dialogue from the knowledge base, and;
creating a message based on gathered information.

29. The method of claim 25, wherein the method further includes the steps of:
accessing information gathered on the product's use;
determining times for future contacts based on the accessed information; and
creating the message based on said accessed information.

30. The method of claim 25 where informing the end user further comprises the steps of:
asking the end user screening questions to determine the end user's needs;
selecting from a plurality of questions those most relevant to the end user's needs to define a subset of questions based on response to said screening questions; and
refining from said subset of questions further subsets of questions to associate the end user's need with a product.

31. A system for marketing a product comprising the steps of:
comprising:
a general purpose computer capable of executing a portion of the an instruction set of a software product;
a software product where the software product controls a general purpose computer performing the following instruction sets:
reviewing information relating to an end user's use of a product, wherein the end user is targeted to be contacted based on that use;
gathering information based on the reviewed information regarding an end user's use of a product to be communicated to the end user; and
communicating to the end user gathered information relating to proper use of the product via an automated message system, wherein the gathered information is communicated to the end user.

32. The system of claim 31 where said system contains instructions for gathering information further comprises collecting the data from a party manufacturing the product, a party selling the product, a party promoting a product, or a party purchasing the product for resale.

33. The system of claim 31 where said system contains instructions for communicating further comprising an audio message using a predetermined vocal persona.

34. The system of claim 31 where said system contains instructions for gathering information, further comprising the steps of:
accessing a knowledge base based on the reviewed information;
associating reviewed information with appropriate dialogue from the knowledge base, and;
creating a message based on gathered information.

35. The system of claim 31 where said system contains instructions, further comprising the steps of:
accessing information gathered on the product's use;
determining times for future contacts based on the accessed information; and
creating the message based on said accessed information.

36. The system of claim 31 where said system contains instructions for informing the end user further comprises the steps of:
asking the end user screening questions to determine the end user's needs;
selecting from a plurality of questions those most relevant to the end user's needs to define a subset of questions based on response to said screening questions; and
refining from said subset of questions further subsets of questions to associate the end user's need with a product.

37. A computer usable medium having a computer readable program code means embodied therein for a manufacturer to supply an end user with information on the client's product with an automated message, the computer usable medium comprising:
a computer readable program code means for reviewing information relating to an end user's use of a product, wherein the end user is targeted to be contacted based on that use;
a computer readable program code means for gathering information based on the reviewed information regarding an end user's use of a product to be communicated to the end user; and
a computer readable program code means for communicating to the end user gathered information relating to proper use of the product via an automated message system, wherein the gathered information is communicated to the end user.

38. The computer usable medium of claim 37 further comprising the steps of gathering information further comprises collecting the data from a party manufacturing the product, a party selling the product, a party promoting a product, or a party purchasing the product for resale.

39. The computer usable medium of claim 37 further comprising the steps of generating an audio message using a predetermined vocal persona.

40. The computer usable medium of claim 37 further comprising the steps of gathering information, further comprising the steps of:
accessing a knowledge base based on the reviewed information;
associating reviewed information with appropriate dialogue from the knowledge base, and;
creating a message based on gathered information.

41. The computer usable medium of claim 37 further comprising the steps of creating an automated message, further comprising the steps of:
accessing information gathered on the product's use;
determining times for future contacts based on the accessed information; and
creating the message based on said accessed information.

42. The computer usable medium of claim 37 further comprising the steps of informing the end user further comprises the steps of:
asking the end user screening questions to determine the end user's needs;
selecting from a plurality of questions those most relevant to the end user's needs to define a subset of questions based on response to said screening questions; and
refining from said subset of questions further subsets of questions to associate the end user's need with a product.
